(19) United States
(12) Patent Application Publication
(10) Pub. No.: US 2007/0280210 A1
(43) Pub. Date: Dec. 6, 2007

(54) Selective transmission of multiparty VOIP communications

(75) Inventors: David Milstein, Redmond, WA (US); Linda Criddle, Kirkland, WA (US); Scott C. Forbes, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/443,590

(22) Filed: May 30, 2006

(51) Int. Cl. H04L 12/66

(52) U.S. Cl. 370/356

(57) ABSTRACT

Generally described, embodiments of the present invention provide a method system for selectively transmitting data packets of a conversation to clients in a group. A group identifier is associated with a group and data packets exchanged during the conversation are processed and transmitted according to the group identifiers included in the data packet. Clients associated with a device group are determined and a group identifier is created to represent the group. Processing and selectively transmitting data packets exchanged during the conversation according to the group identifiers includes determining the group identifiers contained in a received data packet and transmitting the data packet to the clients having associated with the identified group.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. However, current VoIP approaches may not allow users to specify preferences or a set of rules relating to processing VoIP data packets, e.g., rules relating to routing VoIP data packets to particular groups based on affiliation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method for routing data packets of a conversation to devices in a device group is disclosed. The method comprises associating a group identifier with a device group and processing data packets exchanged during the conversation according to the group identifiers. Associating a group identifier with the device group comprises: identifying devices in the device group; associating the group identifier with each of the devices in the device group; and adding the device group to the device group list.

The method may also further comprise specifying a device as a controller for the device group. The controller controls which devices may be added to a device group and may also control which devices in a device group can also become controllers. Metadata for a device provided as contextual data may be used to determine if a device should be added to an existing device group. A set of rules provided as contextual data may also be used to automatically determine if a device should be added to an existing device group.

Processing data packets exchanged during the conversation according to the group identifiers comprises determining the group identifiers in a data packet received from a device in the conversation and transmitting the data packet to the devices having the group identifiers. If there are no group identifiers in a data packet, the data packet is transmitted to all devices in a conversation.

The method may be implemented by a service operated by a service provider or may be implemented as an application that operates on each device in a conversation.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a VoIP environment for establishing a conversation channel between various clients in accordance with an aspect of the present invention;

FIG. 2 is a block diagram of a VoIP client in accordance with an aspect of the present invention;

FIG. 3 is a block diagram of various components associated with a VoIP device in accordance with an aspect of the present invention;

FIGS. 4A and 4B are block diagrams of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIG. 7 is a block diagram illustrating an exemplary affiliation group supported by an exemplary affiliation service;

FIGS. 8-12 are block diagrams of various attributes and classes of structured hierarchies corresponding to VoIP contextual information in accordance with an aspect of the present invention;

FIG. 13 is a block diagram illustrating a typical network environment in which an affiliation service may operate;

FIG. 14A is a functional flow diagram illustrating an exemplary process for creating a group;

FIG. 14B is a functional flow diagram illustrating an exemplary process for processing packets according to group identifiers;

FIG. 14C is an exemplary functional flow diagram for an exemplary process for assigning members to a group; and

FIG. 14D is a functional flow diagram illustrating an exemplary method for assigning controller rights to a group member.

### DETAILED DESCRIPTION

Generally described, the present invention relates to a method and system for processing contextual information relating to a conversation over a communication channel. More specifically, the present invention relates to a method and system for establishing a conversation channel based on client-specified rules and conditions by utilizing contextual information of clients in conjunction with “structured hierarchies”. “Structured hierarchies,” as used herein, are predefined organizational structures for arranging contextual information to be exchanged between two or more VoIP devices. For example, structured hierarchies may be XML namespaces. Further, a VoIP conversation is a data stream of information related to a conversation, such as contextual information and voice information, exchanged over a conversation channel. Although the present invention will be described with relation to illustrative structured hierarchies and an IP telephony environment, one skilled in the relevant art will appreciate that the disclosed embodiments are illustrative in nature and should not be construed as limiting.

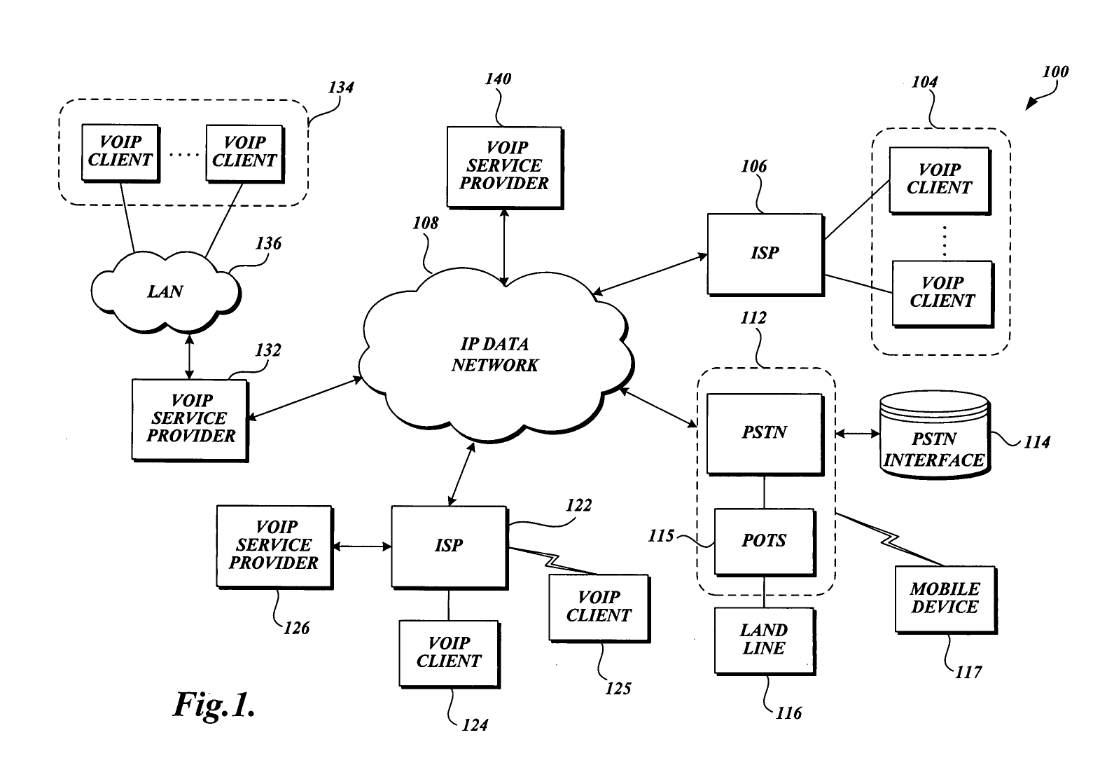

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices and a unique VoIP client identifier collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN) and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 136 may create, maintain, and provide information relating to predetermined priorities for incoming calls. In addition, the VoIP service providers 126, 132, 140 may also generate, maintain, and provide a separated set of affiliation information (e.g., provider affiliation group list) for individuals communicating in a call conversation. The VoIP service providers 126, 132, 140 may determined and assign an appropriate group ID to data packets based on affiliation information provided by VoIP clients 104, 124,.125, 136 in conjunction with the affiliation group list.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 communicatively connected to a PSTN 112. A PSTN interface 114 such as a PSTN gateway may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116 may request a connection with the VoIP client based on the unique VoIP identifier of that client and the appropriate VoIP device associated with the VoIP client, will be used to establish a connection. In one example, an individual associated with the VoIP client may specify which devices are to be used in connecting a call based on a variety of conditions (e.g., connection based on the calling party, the time of day, etc.).

It is understood that the above mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

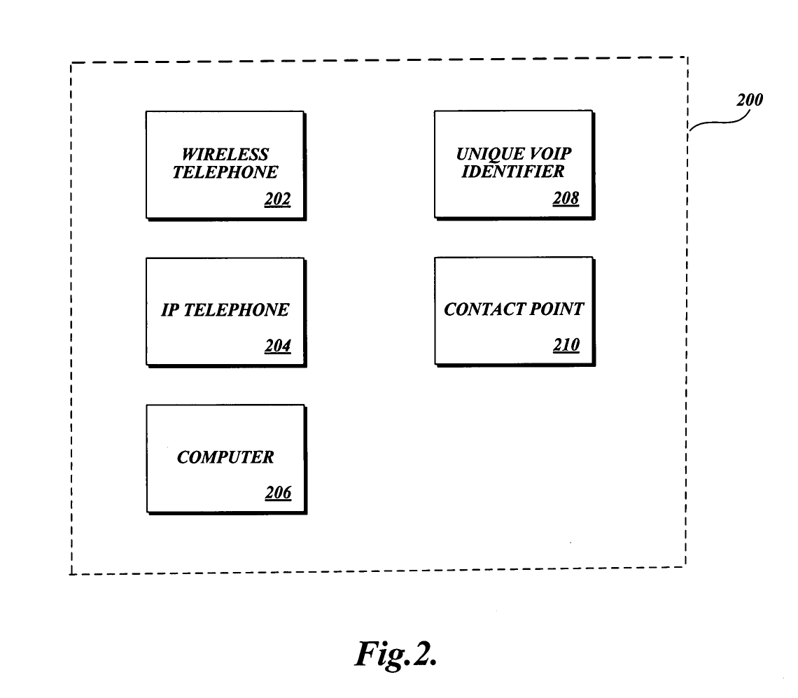

Referring now to FIG. 2, a block diagram illustrating an exemplary VoIP client 200 that includes several VoIP devices and a unique VoIP identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique VoIP identifier 208. The unique VoIP identifier(s) 208 may be constant or change over time. For example, the unique identifier(s) 208 may change with each call. The unique VoIP identifier is used to identify the client and to connect with the contact point 210 associated with the VoIP client. The unique VoIP identifier may be maintained on each VoIP device included in the VoIP client and/or maintained by a service provider that includes an association with each VoIP device included in the VoIP client. In the instance in which the unique VoIP identifier is maintained by a service provider, the service provider may include information about each associated VoIP device and knowledge as to which device(s) to connect for incoming communications. In alternative embodiment, the VoIP client 200 may maintain multiple VoIP identifiers. In this embodiment, a unique VoIP identifier may be temporarily assigned to the VoIP client 200 for each call session.

The unique VoIP identifier may be used similar to a telephone number in PSTN. However, instead of dialing a typical telephone number to ring a specific PSTN device, such as a home phone, the unique VoIP identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

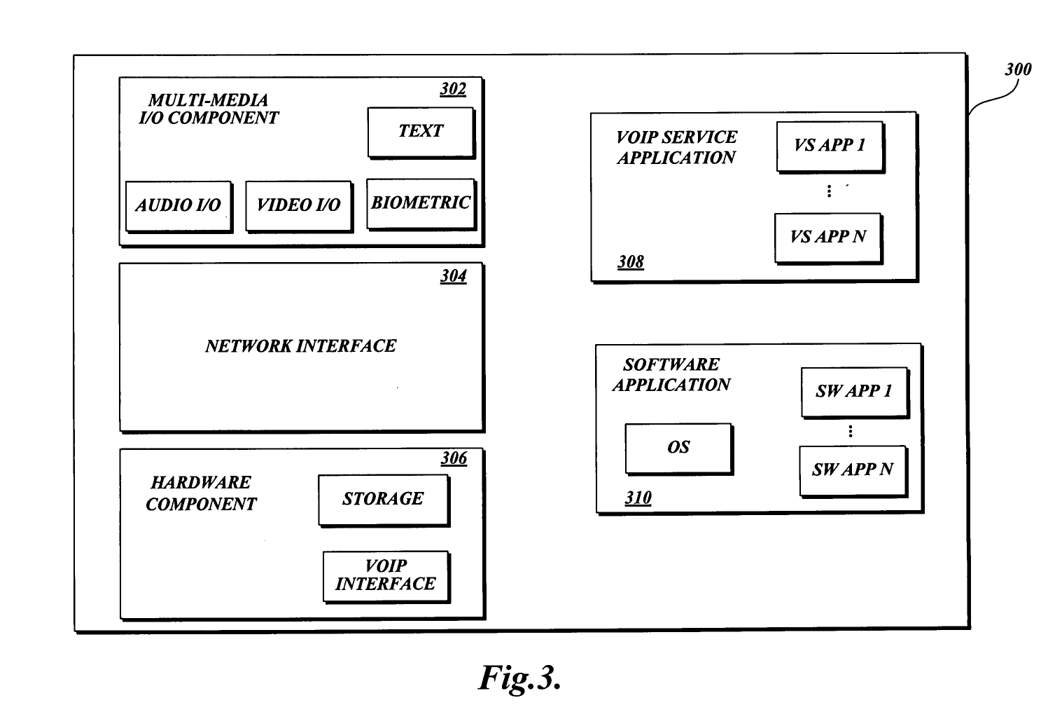

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles, user biometrics information, etc) associated with the VoIP client in which the device is included. In one embodiment, the hardware component 306 may include a VoIP interface card which allows non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services. The CODEC may use voice profiles to filter and improve incoming audio.

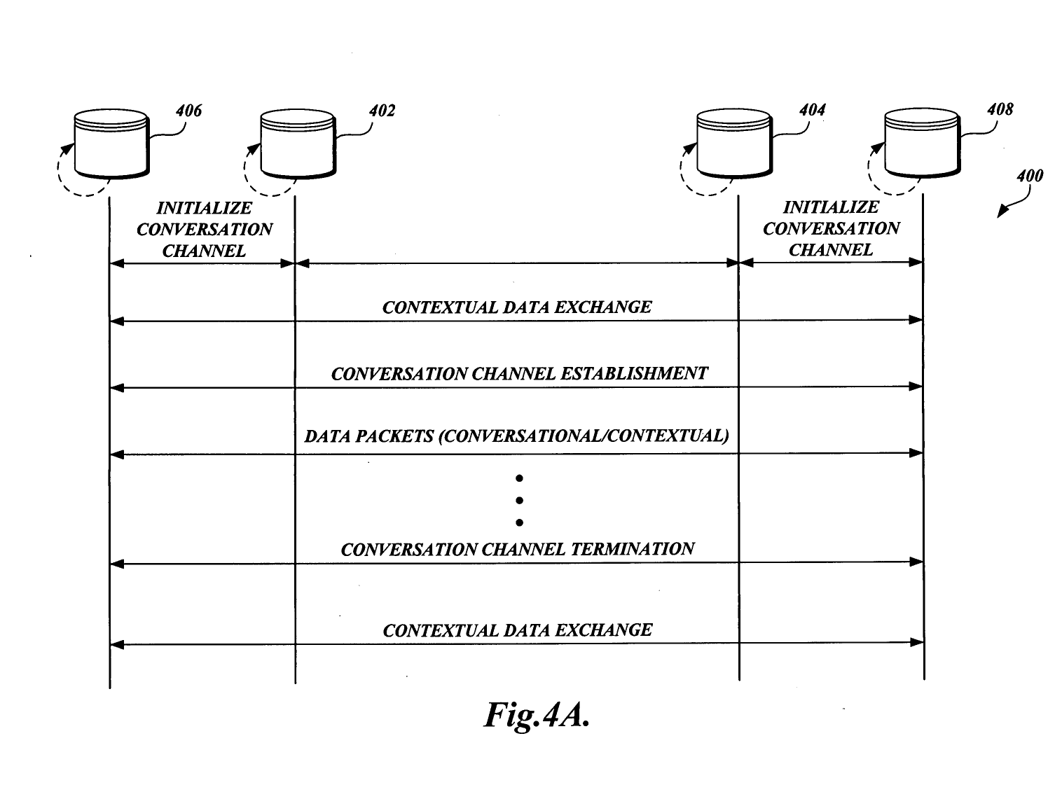

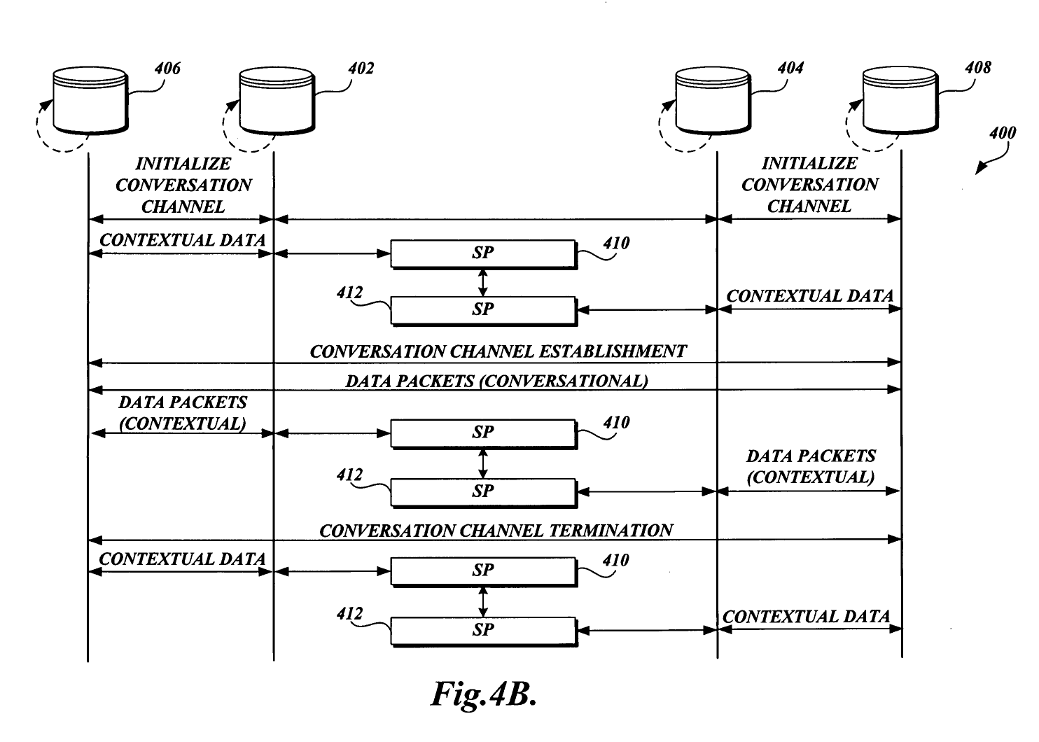

With reference to FIG. 4A, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which both the first VoIP client 406 and the second VoIP client 408 each only includes one VoIP device. Accordingly, the discussion provided herein will refer to connection of the two VoIP devices. The individual using the device of the first VoIP client 406 may select or enter the unique VoIP identifier of the client that is to be called. Provider 1 402 receives the request from the device of the first VoIP client 408 and determines a terminating service provider (e.g., Provider 2 404 of the second VoIP client 408) based on the unique VoIP identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. For example, the contextual information sent from the called VoIP client 406 may include priority list of incoming calls from various potential calling VoIP clients including VoIP client 406.

Available media types, rules of the calling client and the client being called, and the like, may also be part of the contextual information that is exchanged during the connection set-up phase. The contextual information may be processed and collected by one the devices of the first VoIP client 406, one of the devices of the second VoIP client 408, and/or by VoIP service providers (e.g., Provider 1 402 and Provider 2 404), depending on the nature of the contextual information. In one embodiment, the VoIP service providers 402, 404 may add/or delete some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

FIG. 4B is a block diagram illustrative of a conversation flow 400 between devices of two VoIP clients via several service providers, in accordance with an embodiment of the present invention. As with FIG. 4A, the example described herein will utilize the scenario in which each client only has one device associated therewith and the connection occurs between those two devices. During a connection set-up phase, a device of a first VoIP client 406 requests to initiate a conversation channel for communication with a second VoIP client 408. In an illustrative embodiment, a VoIP service provider 402 (Provider1) for the first VoIP client 406 receives the request to initiate a conversation channel and forwards the request to a VoIP service provider 404 (Provider2) for the second VoIP client 408.

Before the device of the first VoIP client 406 and the device of the second VoIP client 408 begin to exchange voice data packets, contextual information may be exchanged between the first VoIP client 406 and the second VoIP client 408. Contextual information may be exchanged using a structured organization defined by the first VoIP client 406. In one embodiment, Provider 1 402 may identify particular contextual information which Provider 1 402 desires to obtain from the first VoIP client 406. The first VoIP client 406 may specify the corresponding structure based on the content of the contextual information. The identification of the structure for exchanging information and additional contextual information may be transmitted to the second VoIP client 408 via Provider 2 404 and Provider 1 402.

The contextual information may be processed and collected at a device of the first VoIP client, a device of the second VoIP client, and/or the VoIP service providers (e.g., Provider1 and Provider2), depending on the nature of the contextual information. For example, voice profiles may be collected by the service providers 402, 404, and only temporarily provided to the devices. Further, third party Service Provider(s) (third party SP) 410, 412 can obtain and/or add contextual information exchanged among devices of the first VoIP client 406 and second VoIP client 408, Provider 1 402, and Provider 2 404. In one embodiment, any of Provider 1 402, Provider 2 404, and third party SP 410, 412 may add, modify and/or delete contextual information before forwarding the contextual information to the next VoIP device(s), including other service providers.

In response to a request to initiate a conversation channel, the second VoIP client 408 may accept the request for establishing a conversation channel or reject the request via Provider 2 404. When a conversation channel has been established, the devices of the first VoIP client 406 and the second VoIP client 408 start communicating with each other by exchanging data packets as discussed above. In one embodiment, contextual and/or conversation data packets may be forwarded to third party SPs 410, 412 from Provider 1 402, Provider 2 404, or from either VoIP client 406, 408. Further, the forwarded contextual and/or conversation data packets may be exchanged among various third party SPs 410, 412.

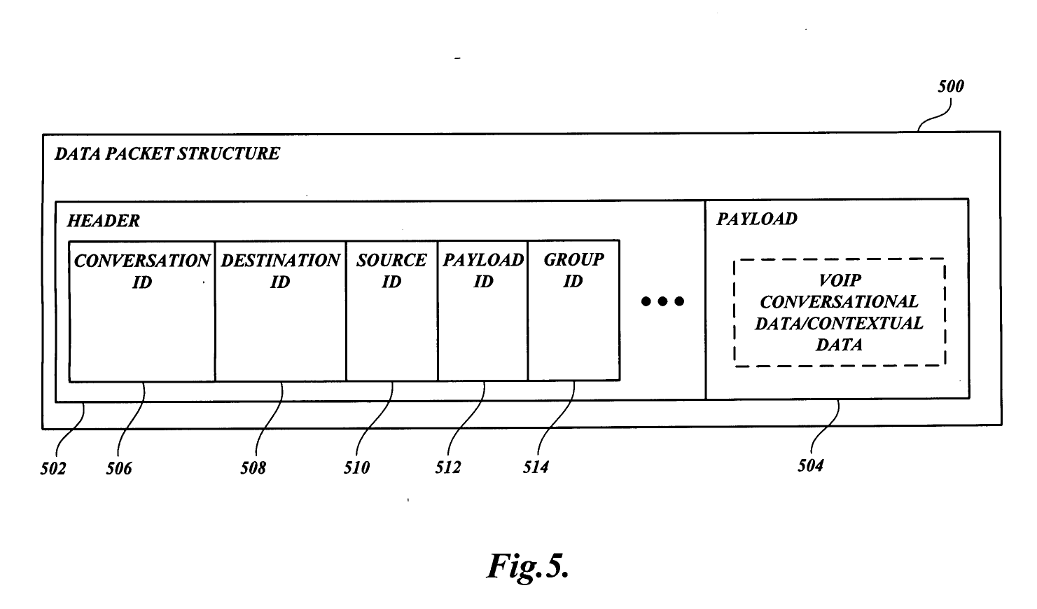

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique VoIP identifier of the client being called, a Source ID 510 (unique VoIP identifier of the calling client or device identifier), Payload ID 512 for identifying type of payload (e.g., conversation or contextual), Group ID 514 for identifying a group with which the data packet is associated, individual ID (not shown) for identifying the individual for which the conversation data is related, and the like. It is also possible for a data packet to contain more than one Group ID 514 to identify more than one group with which the data packet is associated In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context) and the like. More specifically, the contextual information may include client preference, client rules, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete VoIP client's contextual data before forwarding the contextual information. For example, client's confidential information will be deleted by the VoIP service provider associated with that client unless the client authorizes such information to be transmitted. In some cases, a minimal amount of contextual information is transmitted outside of an intranet network.

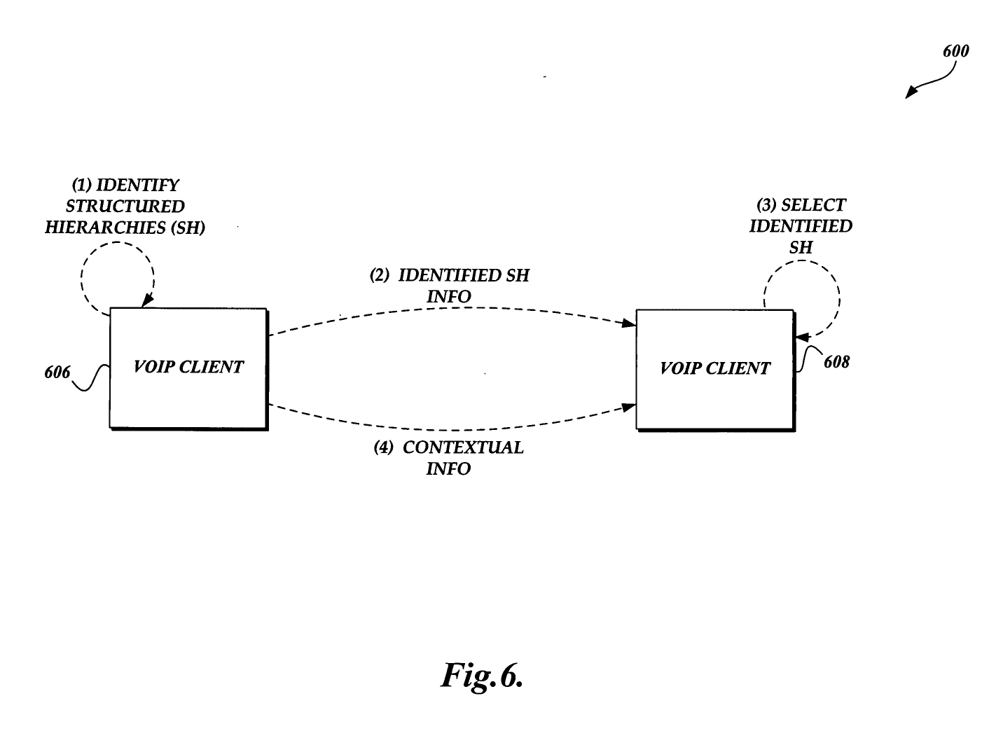

With reference to FIG. 6, a block diagram 600 illustrating interactions between two VoIP clients for transferring contextual information, in accordance with an embodiment of the present invention, is shown. As with FIGS. 4A and 4B, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information about which structured hierarchy is used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

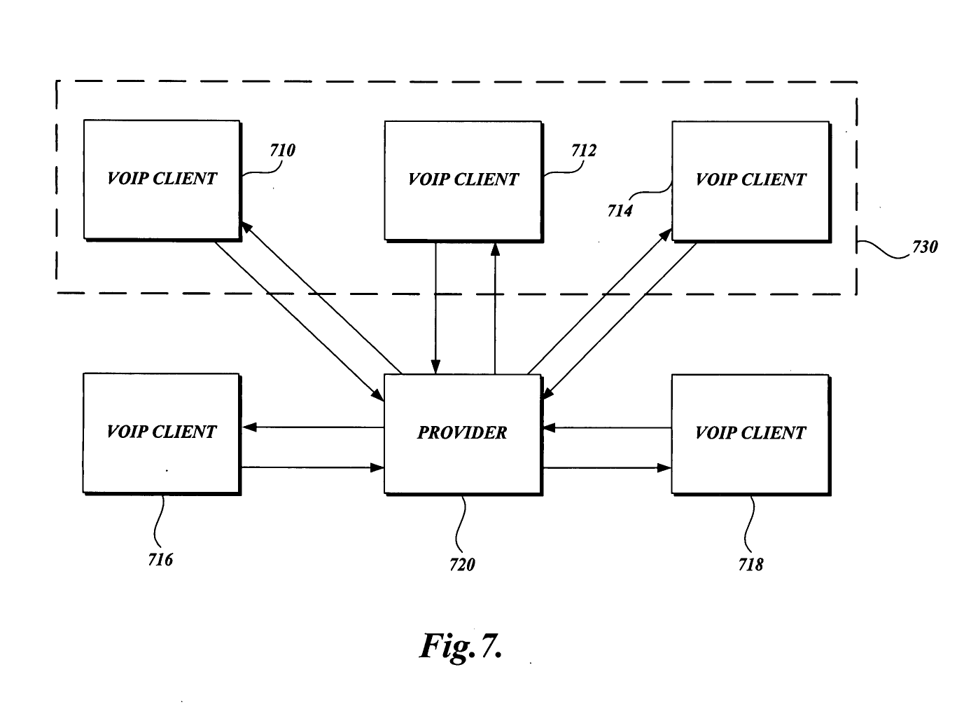

FIGS. 7A-7C are block diagrams 700 illustrating interactions among VoIP entities in the VoIP environment utilizing data packet selection in accordance with an aspect of the present invention. In one embodiment, the VoIP entities may include VoIP clients, VoIP service providers for the clients, third party service providers and the like. It is to be noted that one of ordinary skill in the relevant art will appreciate that any suitable entities may be included in the IP telephone environment.

The contextual information represented in accordance with the identified structured hierarchies described above may be used to support an affiliation service that provides a way to route data packets of a conversation to devices based on affiliation groups. FIG. 7 is a block diagram illustrating an exemplary affiliation group supported by an exemplary affiliation service. In FIG. 7, a Provider 720 provides an affiliation service for VoIP clients 710, 712, 714, 716, and 718. VoIP clients 710, 712 and 714 belong to an affiliation group 730, for example, a group of rare book traders. VoIP clients 710, 712 and 714 are each used by a trader. VoIP clients 716 and 718 are not traders and are not members of the trader affiliation group, i.e., the trader group 730. The Provider 720 routes data packets to VoIP clients 710, 712, 714, 716, and 718 based on affiliation groups, e.g., the trader group 730. For example, the VoIP client 710 transmits a data packet intended for the trader group 730. Perhaps the data packet has to do with a particular rare book to be traded. The Provider 720 examines the data packet. If the data packet contains a trader group identifier, the data packet is transmitted only to members of the trader group 730 which are VoIP clients 712 and 714. The data packet is not transmitted to VoIP clients 716 and 718. In effect, only members of the trader group are allowed to trade the rare book.

Alternatively, the VoIP client 710 may transmit a data packet addressed to VoIP client 712 and VoIP client 716 and the Provider 720 examines the data packet. If the data packet contains a trader group identifier, the data packet is transmitted only to VoIP client 712, a member of the trader group 730. The data packet is not transmitted to VoIP client 716, which is not a member of the trader group 730.

Preferably, affiliation groups may be created by a VoIP client by transmitting a request to an affiliation service provider. For example, the VoIP client 714 may create the trader group 730 by transmitting a request to Provider 720. When the Provider 720 receives the request, the Provider 720 creates the trader group 730, creates a unique ID for the trader group 730, adds VoIP client 714 to the trader group 730, and assigns controller rights to VoIP client 714. Thereafter, to add new members to the trader group 730 or to remove existing members from the trader group 730, the controller, i.e., VoIP client 714 transmits requests to the Provider 720. A member of the trading group 730 may also be assigned controller rights by a controller. For example, VoIP client 714 may transmit a request to the Provider 720 to assign controller rights to VoIP client 712. Alternatively, there may be a primary controller and multiple secondary controllers. A primary controller is permitted to add and remove group members and assign controller rights. A secondary controller is only permitted to add and remove group members but is not permitted to assign controller rights.

As mentioned above, structured hierarchies may be identified for communicating contextual information corresponding to called VoIP client's affiliation information. Further, the information regarding the identified structured hierarchies may be transmitted. The information regarding the identified structured hierarchies may include the information about which structured hierarchies carry the contextual information, how to identify the structured hierarchies, and the like. Subsequently, the contextual information corresponding to priority information may be represented in accordance with the identified structured hierarchies and transmitted.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software and hardware independent tool for transmitting information. Further, XML maintains its data as a hierarchically-structured tree of nodes, each node comprising a tag that may contain descriptive attributes. Typically, a XML namespace is provided to give the namespace a unique name. In some instances, the namespace may be used as a pointer to a centralized location containing default information about the namespace.

In an illustrative embodiment, VoIP Client 606 may identify a XML namespace for contextual information. For example, the XML namespace attribute may be placed in the start tag of a sending element. It is to be understood that XML namespaces, attributes, classes illustrated herein are provided merely as an example of structured hierarchies used in conjunction with various embodiments of the present invention. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information.

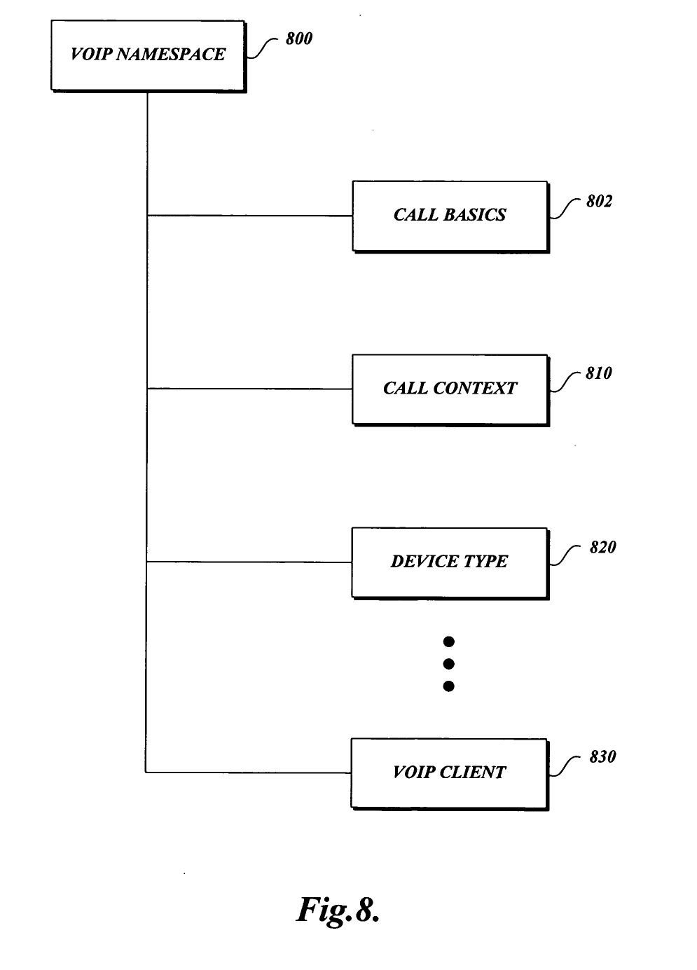

With reference to FIGS. 8-12, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830 and the like.

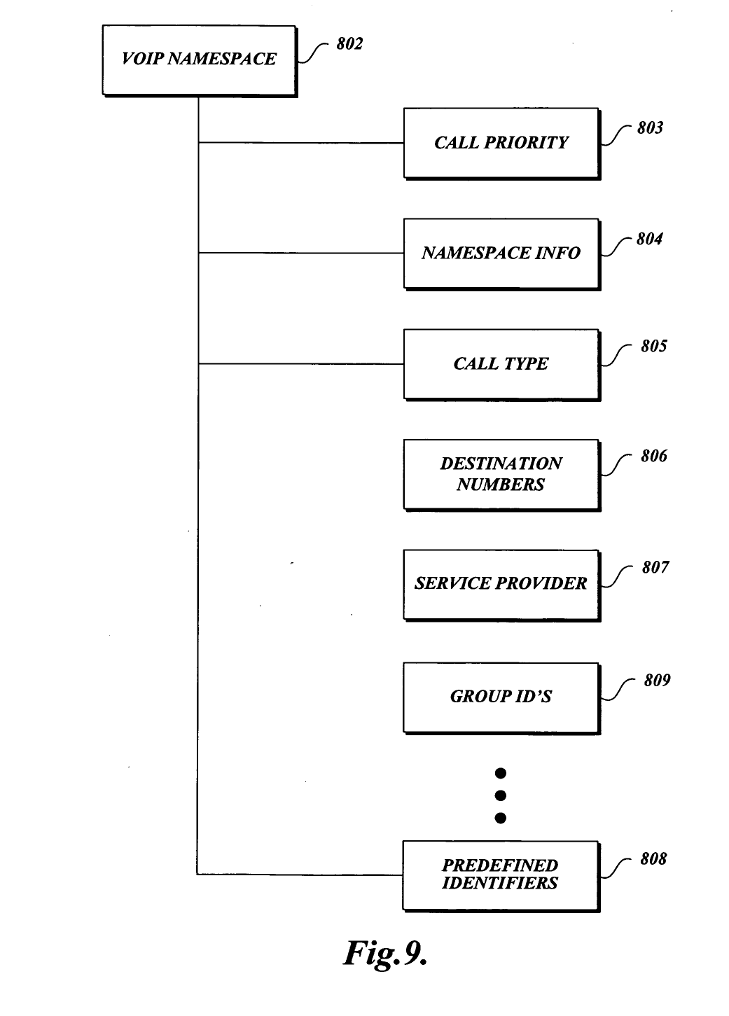

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's VoIP ID number), destination numbers (e.g., callees' VoIP ID numbers or telephone numbers), call connection time, VoIP service provider related information, and/or ISP related information such as IP address, MAC address, namespace information and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah”, “oops”, “wow”, etc.) and facial expressions in graphical symbols. In one embodiment, a Call Basics Class 802 may be defined as a sub-tree structure of a VoIP Namespace 800, which includes nodes such as call priority 803, namespace information 804, call type 805, destination numbers 806, service provider 807, predefined identifiers 808, and the like.

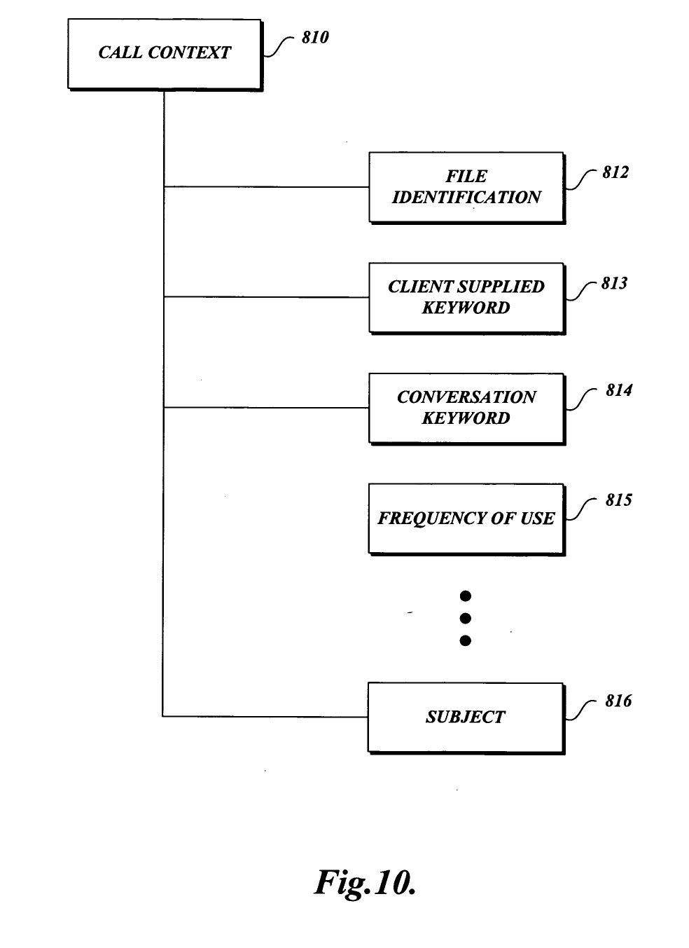

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information such as client supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

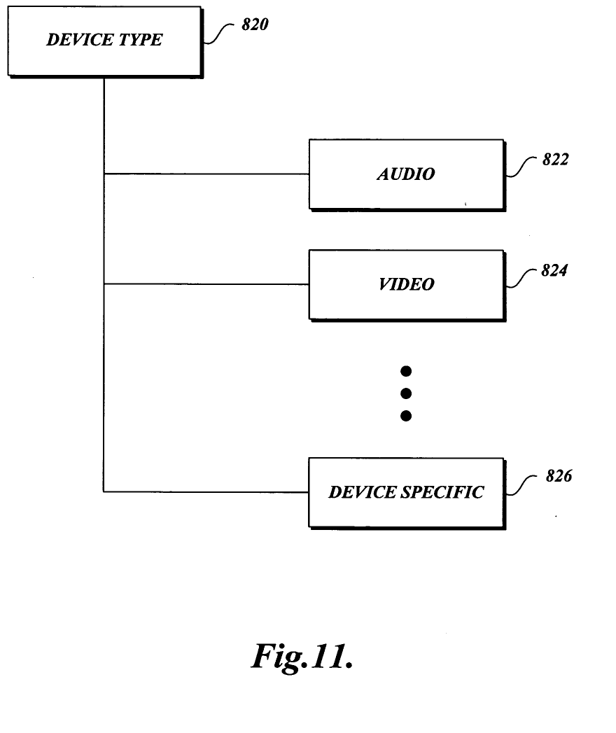

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826 and the like.

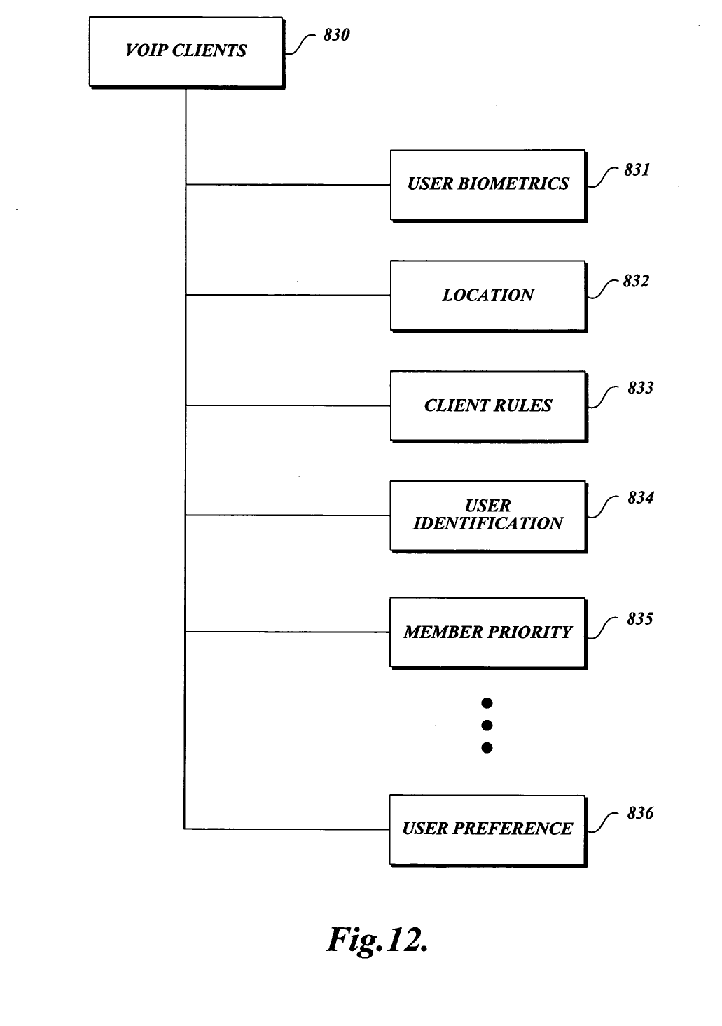

With reference to FIG. 12, a block diagram of a VoIP Client Class 830 is depicted. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. In one embodiment, a VoIP Client Class 830 may be defined as a sub-tree structure of a VoIP Namespace 800, which includes nodes corresponding to user biometrics 831, location 832, client rules 833, user identification 834, member priority 835, user preference 836, and the like.

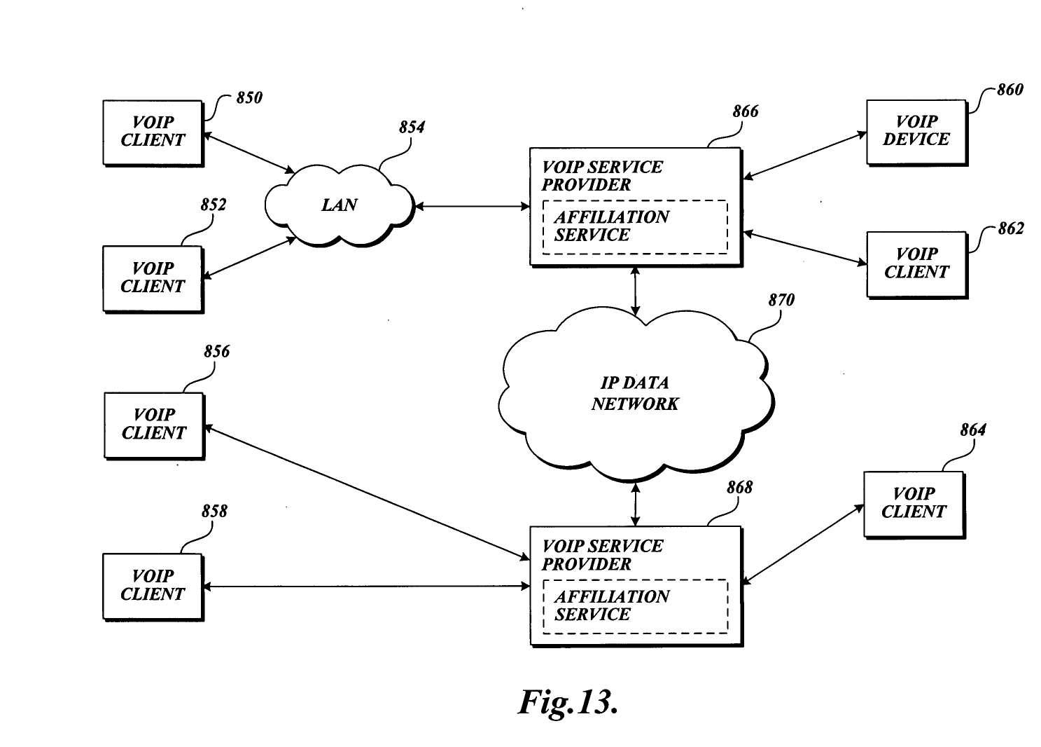

Establishing conversation channels based on client-specified rules and conditions using the contextual information of clients in conjunction with structured hierarchies, as illustrated in FIGS. 1-12 and described above, enables a system to support a service for routing data packets of a conversation to devices in a device group, i.e., an affiliation service. FIG. 13 is a block diagram that illustrates an exemplary network in which an affiliation service may operate. As can be seen in FIG. 13, communication between various VoIP devices through an IP data network is controlled by an affiliation service supported by VoIP service providers. In particular, VoIP devices 850 and 852 are connected to a LAN 854 which is connected to a VoIP service provider 866 supporting an affiliation service. VoIP devices 860 and 862 are also connected to VoIP service provider 866. The VoIP service provider 866 is connected to an IP data network 870. A VoIP device may form a group by transmitting a group creation request to an affiliation service. For example, the VoIP device 850 forms a group by transmitting a group creation request through the LAN 854 to the affiliation service supported by VoIP service provider 866. The group creation request contains a list of group members, e.g., VoIP devices 850, 852, 860. After the affiliation service forms the group and associated group ID, if VoIP device 850 transmits a data packet containing the group ID, the affiliation service routes the data packet through the IP data network 870 to the VoIP devices 850, 852, and 860 but not to the VoIP device 862.

An affiliation service may operate on more than one VoIP service provider, i.e., instances of an affiliation service operate on a plurality of VoIP service providers and the each instance communicates with the other instances. As shown in FIG. 13, the affiliation service operates on VoIP service providers 866 and 868. VoIP devices 856, 858, 864 are connected to VoIP service provider 868 which is connected to the IP data network 870. VoIP devices connected to a VoIP service provider supporting an affiliation service may participate in groups provided by the affiliation service. Extending the example described above, VoIP device 850 adds VoIP devices 856 and 864 to the group by transmitting a request to the affiliation service instance operating on VoIP service provider 866. The affiliation service maintains a list of group members which are VoIP devices 850, 852, 856, 860, 864. Not included in the list are VoIP devices 862 and 858. The affiliation service instance operating on VoIP service provider 866 communicates with the affiliation service instance operating on VoIP service provider 868. Both affiliation service instances have access to the list of group members. If a VoIP device in the group, e.g., VoIP device 864, transmits a data packet containing the group ID, the affiliation service transmits the data packet through the IP data network 870 to the other devices in the group, e.g., VoIP devices 850, 852, 856, 860. The data packet is not transmitted to the VoIP devices 862 and 858.

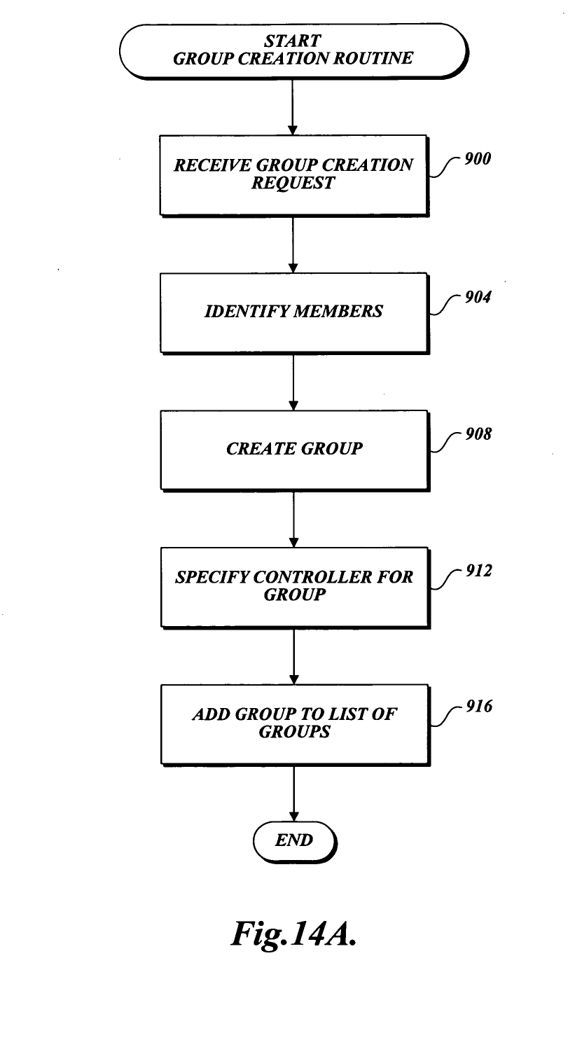

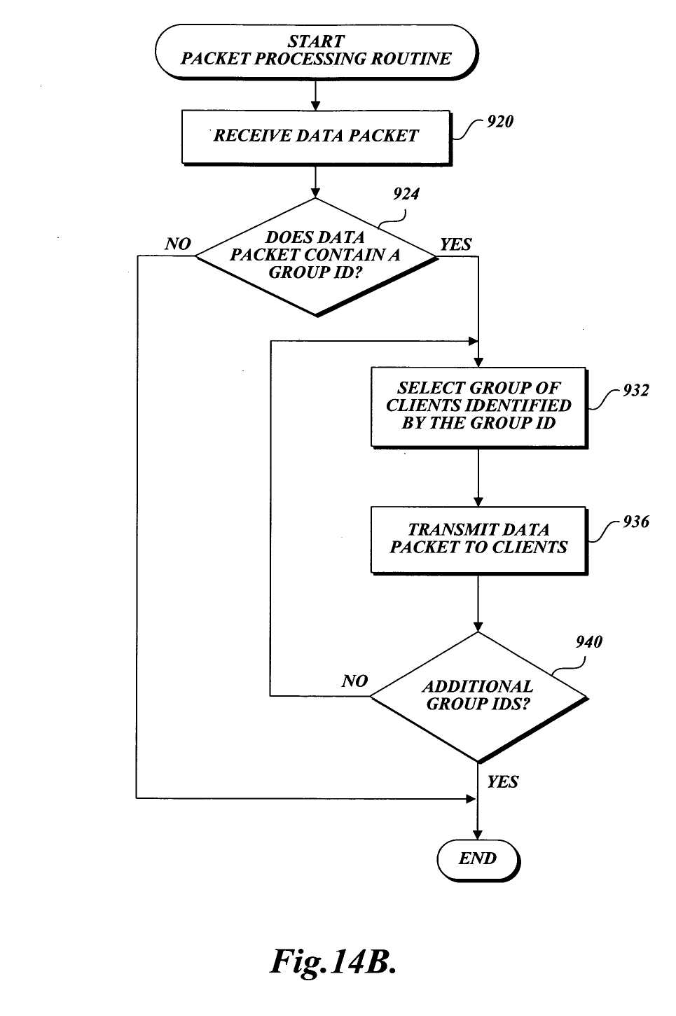

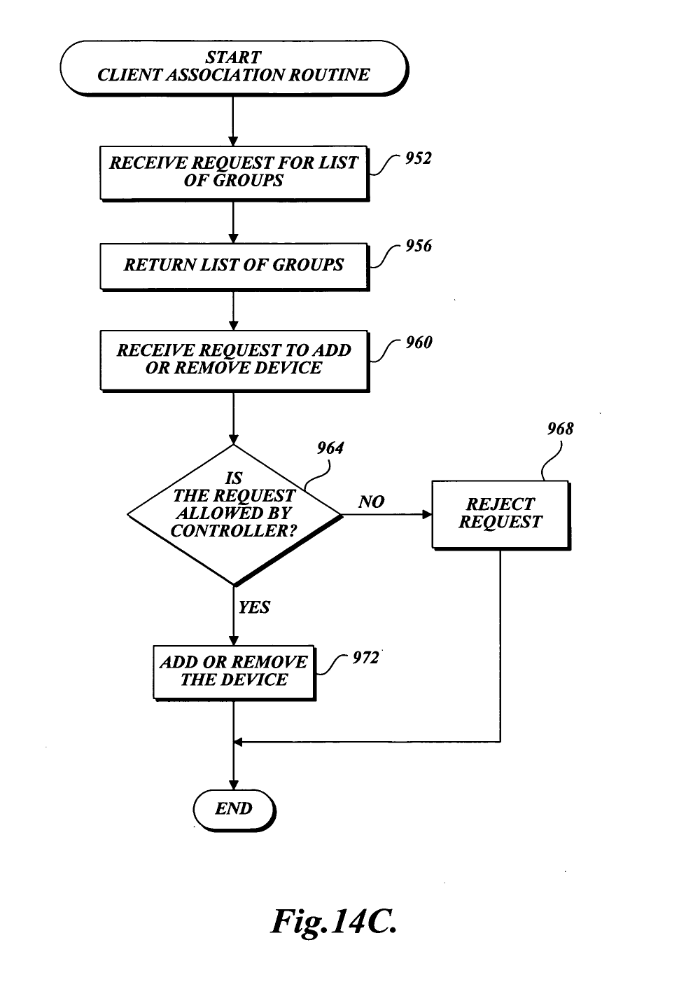

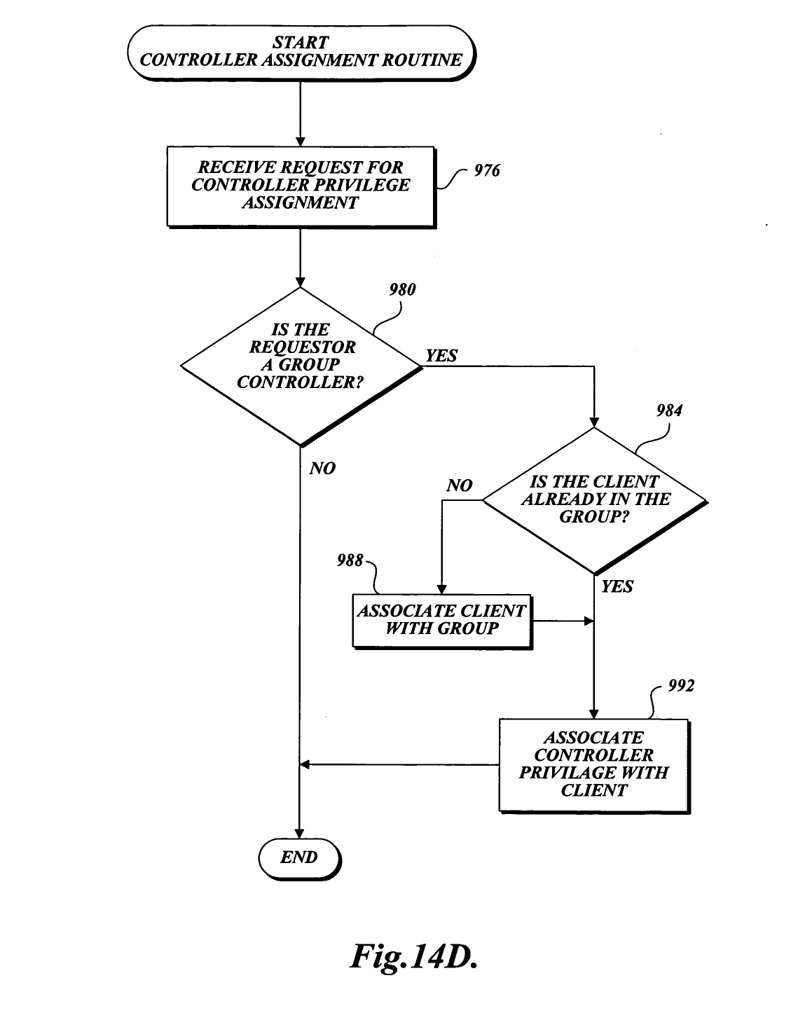

FIG. 14A is a functional flow diagram that illustrates an exemplary process for creating a device group, i.e., group, such as the group described above. The process begins at block 900 where a group creation request is received by the affiliation service. At block 904, members, i.e., group members such as VoIP devices 850, 852, 856, 860, 864, are identified. At block 908, the group is created. In particular, a list of the group members, (herein referred to as a group list) is created and a group ID is created and associated with the group list. At block 912, the group controller is specified. The group controller is usually, but not necessarily, the creator of the group, e.g., VoIP device 850. At block 916, the group list is added to a list of groups maintained by the affiliation service and the process ends.

FIG. 14B is a functional flow diagram illustrating an exemplary process for processing packets that contain group IDs. The process begins at block 920 where a data packet is received by the affiliation service. At decision block 924, the data packet is examined to see if it contains group IDs. If a data packet does not contain group IDs, the process ends. If a data packet contains one or more group IDs, the control flows to block 932 where the next group ID is selected in the list of group IDs in the data packet. The selected group ID is used to select the group list that corresponds to the group ID. At block 936, the data packet is transmitted to members in the group with the selected group ID. At decision block 940, it is determined if the data packet has been transmitted to all groups identified by the group IDs. If the data packet has been transmitted to all groups identified by the group IDs, the process ends. If the data packet has not been transmitted to all the groups identified by group IDs, control flows back to block 932 and the next group ID and group associated with the group ID is selected.

FIG. 14C is a functional flow diagram illustrating an exemplary process for assigning a member to an existing group. Process begins at block 952 where a request is received for a list of groups. At block 956, a list of groups is returned to the requestor. The requestor may, for example, present the list of groups to a user enabling the user to select a group from the list of groups. The requestor may also automatically select a group from the list of groups. The requester may transmit a request to add a device to the selected group. At block 960, a request is received to add a device to a group. At decision block 964, it is determined if the device to be added is allowed by the controller. If the device that was requested to be added is allowed to be added by the controller, the device is added to the group at block 972 and the process ends. If it is determined at decision block 964 that the device is not allowed to be added by the controller, then the device addition request is rejected at block 968 and the process ends.

FIG. 14D is a functional flow diagram illustrating an exemplary process for assigning controller rights to a device in a device group. The process begins at block 976 where a request for controller privilege assignment for a device is received. At decision block 980 it is determined if the requester is a group controller. If the requestor is not a group controller, the process ends. For example, VoIP device 850 is a controller and transmits a request to the affiliation service requesting that VoIP device 860 be assigned controller rights. If the requester is a group controller, the control flows to decision block 984 where it is determined if the device is already in the group. If the device is already in the group, then control flows to block 992 where the controller privilege is added to the device's record and the process ends. If the device is not already in the group, then at block 988 the device is added to the group and control flows to block 992 where controller privileges are added to the device's record.

While illustrative embodiments have been illustrated and described, it will be appreciated that various changes can be made therein without departing from the spirit and scope of the invention

The embodiments of the invention in which an exclusive property or privilege is claimed are defined as follows:

1. A method for selectively transmitting data packets of a conversation to clients, comprising:
(a) creating a group and associating at least one client with the group;
(b) defining a group identifier for the group; and
(c) transmitting data packets of the conversation to clients associated with the group.

2. The method of claim 1, wherein defining a group identifier for the group comprises:
(a) generating a unique identifier to be used as the group identifier;
(b) creating a group list identifying the associated clients; and
(c) associating the group identifier with the group list.

3. The method of claim 1, wherein a client is added to an existing group by associating the client with the group and identifying the client in the group list.

4. The method of claim 1, wherein metadata for a client is used to automatically determine if the client should be added to an existing group.

5. The method of claim 4, wherein the metadata for the client is provided as contextual data.

6. The method of claim 1, wherein a set of rules is used to automatically determine if a client should be added to an existing group.

7. The method of claim 6, wherein the set of rules is provided as contextual data.

8. The method of claim 1, wherein the method is implemented by an affiliation service operated by a service provider.

9. The method of claim 1, wherein the method is implemented by that operates on each device in the conversation.

10. The method of claim 1, wherein transmitting data packets comprises:
(a) receiving data packet from a client;
(b) determining if a group identifier is included in the data packet; and
(c) transmitting the data packet to the clients associated with the identified group.

11. The method of claim 10 further comprising:
if it is determined that there is no group identifier in the data packet, the data packet is not transmitted.

12. A computer-readable medium having computer-executable components for processing data packets exchanged between clients in a conversation comprising:
(a) an affiliation component creating a group identifier and associating a plurality of clients with the group identifiers;
(b) a data packet processing component determining a group identifier in a data packet; and
(c) a transmitting component transmitting the data packet to the clients associated with the determined group identifier.

13. The computer-readable medium of claim 12, wherein a controller component controls the addition of clients to an existing group.

14. The computer-readable medium of claim 12, wherein a controller component determines if a client in a group may also become a controller of the group.

15. The computer-readable medium of claim 12, wherein a set of rules automatically controls the addition of clients to an existing group.

16. The computer-readable medium of claim 15, wherein the set of rules for automatically controlling the addition of clients to an existing group is provided as metadata.

17. The computer-readable medium of claim 16, wherein the metadata is provided as contextual data.

18. A system for selectively transmitting data packets of a conversation to clients, comprising:
(a) a plurality of groups;
(b) group IDs for the groups; and
(c) at least one controller for each of the groups.

19. The system of claim 18, wherein the at least one controller controls whether a client may be added to the group.

20. The system of claim 18, wherein the at least one controller controls which clients in the group can also become controllers.
